(19) United States
(12) Patent Application Publication
(10) Pub. No.: US 2026/0359992 A1
(43) Pub. Date: Nov. 12, 2026

(54) METHOD AND SYSTEM FOR OPTICALLY TRACKING MOVING OBJECTS

(71) Applicant: TOPGOLF SWEDEN AB, Danderyd (SE)

(72) Inventor: Stein Norheim, Spånga (SE)

(21) Appl. No.: 19/120,713

(22) PCT Filed: Oct. 6, 2023
(86) PCT No.: PCT/EP2023/077799

§ 371 Date: Apr. 11, 2025

(30) Foreign Application Priority Data
Oct. 17, 2022 (SE) 2230331-7

(51) Int. Cl. G06T 7/215

(52) U.S. Cl. CPC G06T 7/215; G06T 2207/10016; G06T 2207/30224; G06T 2207/30241

(57) ABSTRACT

Methods, systems, and apparatus, including computer program products, for tracking moving objects include depicting a space using a digital camera to produce a series of digital images (Iₜ); for two or more of said pixel values, determining an inequality comparing a first value to a second value, the first value being calculated based on the square of the difference between a pixel value (i_{x,y,t}) and a predicted pixel value (AA), the second value being calculated based on a product of the square of a number Z and an estimated variance for historic pixel values; storing in a computer memory information indicating that the pixel value (i_{x,y,t}) is part of a detected blob; and correlating detected blobs across said 10 series of digital images (Iₜ) to determine paths of moving objects.

### BACKGROUND OF THE INVENTION

The present invention relates to a method and a system for optically tracking moving objects.

Known methods track moving objects using computer vision, using one or more cameras depicting a space where the moving objects exist. The tracking may be performed by first identifying an object as one image pixel, or a set of adjacent pixels, that deviate from a local background. Such deviating pixels are together denoted a “blob”. Once a number of blobs have been detected in several image frames, possible tracked object paths are identified by interconnecting identified blobs in subsequent frames.

One example of such a method is exemplified in US20220051420 A1.

The blob generation in each individual frame potentially results in very many false positive blobs, in other words identified blobs that do not really correspond to an existing moving object. This may be due to noise, shifting lighting conditions and non-tracked objects occurring in the field of view of the camera in question.

The detection of possible tracked object paths normally results in a reduction of such false positives, for instance based on filtering away of physically or statistically implausible paths. Due to the large number of false positive blob detections, however, even if most of the false positives are filtered away in the tracked paths detection step, the blob detection itself is associated with heavy memory and processor load and may therefore constitute a bottleneck for the object tracking even if high-performance hardware is used.

Moreover, as the performance of digital cameras increases, pixel data output from such cameras increases correspondingly. In order to achieve accurate tracking of moving objects, it is desired to use as accurate and precise image information as possible.

In order to avoid too many non-detected blobs (false negatives), leading to potentially missed tracked object paths, it is normally preferred to accept a relatively large share of false positive blob detections.

### SUMMARY OF THE INVENTION

The various embodiments described herein solve one or more of the above described problems and provide techniques for tracking the paths of moving objects using less memory and/or processing power compared to conventional object tracking techniques.

Hence, the invention can be embodied as a method for tracking moving objects, comprising the steps
obtaining a series of digital images Iₜ at consecutive times t, the digital images Iₜ representing optical input from a three-dimensional space within a field of view of the digital camera, the digital camera being arranged to produce said digital images Iₜ having a corresponding set of pixels p_{x,y}, said digital images comprising corresponding pixel values i_{x,y,t}, the digital camera not moving in relation to said three-dimensional space during production of said series of digital images (Iₜ);
for two or more of said pixel values i_{x,y,t}, determining an inequality comparing a first value to a second value, the first value being calculated as, or based on, the square of the difference between the pixel value i_{x,y,t} in question and a predicted pixel value \hat{μ}_{x,y,t}, the second value being calculated as, or based on, a product of, firstly, the square of a number Z and, secondly, an estimated variance or standard deviation σ_{x,y,t} with respect to historic pixel values i_{x,y,{t-n,t-1}} for the pixel p_{x,y} in question, where the predicted pixel value \hat{μ}_{x,y,t} is calculated based on historic pixel values i_{x,y,{t-n,t-1}} for the pixel p_{x,y} in question, Z being a number selected such that Z² is an integer such that 10≤Z²≤20;
for pixel values i_{x,y,t} for which said first value is higher than said second value, storing in a computer memory information indicating that the pixel value i_{x,y,t} is part of a detected blob; and
correlating, based on the information stored in the computer memory, detected blobs across said series of digital images Iₜ to determine paths of moving objects through said three-dimensional space.

In some embodiments,
said inequality is

$${( {i}_{x , y , t} - {\hat{μ}}_{x , y , t} )}^{2} > {Z}^{2} {σ}_{x , y , t}^{2} ,$$

where \hat{μ}_{x,y,t} is said predicted pixel value and where σ_{x,y,t} is an estimated standard deviation with respect to historic pixel values i_{x,y,{t-n,t-1}} for the pixel p_{x,y} in question.

In some embodiments, the method further comprises
storing, in said computer memory, for individual ones of said pixels p_{x,y} and for a number n≤N, the sums

$${S}_{x , y , t} = {\sum }_{j = t - n}^{t - 1} {i}_{x , y , j} and {Q}_{x , y , t} = {\sum }_{j = t - n}^{t - 1} {i}_{x , y , j}^{2} ;$$

and
for individual ones of said pixel values i_{x,y,t}, determining said inequality as

$${( {ni}_{x , y , t} - {S}_{x , y , t} )}^{2} > {Z}^{2} ( {nQ}_{x , y , t} - {S}_{x , y , t}^{2} ) .$$

In some embodiments, μvalue i_{x,y,t} is calculated using a previously stored calculated value S_{x,y,t}, Q_{x,y,t}, or both, for the same pixel p_{x,y} but at an immediately preceding time t−1.

In some embodiments,

$${S}_{x , y , t} is calculated as {S}_{x , y , t} = {S}_{x , y , t - 1} + {i}_{x , y , t} - {i}_{x , y , t - n}$$

$$and$$

$${Q}_{x , y , t} is calculated as {Q}_{x , y , t} = {Q}_{x , y , t - 1} + {i}_{x , y , t}^{2} - {i}_{x , y , n - 1}^{2} = {Q}_{x , y , t - 1} + ( {i}_{x , y , t} + {i}_{x , y , t - n} ) ( {i}_{x , y , t} - {i}_{x , y , t - n} ) .$$

In some embodiments, the method further comprises
storing in said computer memory S_{x,y,t} and Q_{x,y,t} in combination as a single datatype comprising 12 bytes or less per pixel p_{x,y}.

In some embodiments, the method further comprises
storing in said computer memory, for a particular digital image Iₜ, a pixmap having, for each pixel p_{x,y}, said information indicating that the pixel value i_{x,y,t} is part of a detected blob.

In some embodiments,
said information indicating that the pixel value i_{x,y,t} is part of a detected blob is indicated in a single a bit for each pixel p_{x,y}.

In some embodiments,
said pixmap also comprises, for each pixel p_{x,y}, a value indicating an expected pixel value i_{x,y,t} for that pixel p_{x,y}.

In some embodiments,
said value indicating an expected pixel value i_{x,y,t} for the pixel p_{x,y} in question by storing the predicted pixel value (\hat{μ}_{x,y,t}) as a fixed-point fractional number, using a total of 15 bits for the integer and fractional parts.

In some embodiments,
the predicted pixel value \hat{μ}_{x,y,t}, the estimated variance or standard deviation σ_{x,y,t}, or both, is or are calculated based on a set of n historic pixel values i_{x,y,{t-n,t-1}} for the pixel p_{x,y} in question, where 10≤n≤300.

In some embodiments,
a number n of previous images Iₜ considered for the estimation of an estimated variance or a standard deviation σ_{x,y,t} of the second value is selected to be a power of 2.

In some embodiments,
said pixel values i_{x,y,t} have a depth across one or several channels of between 8 and 46 bits.

In some embodiments,
the predicted pixel value \hat{μ}_{x,y,t} is determined based on an estimated projected future mean pixel value μ_{x,y,t} in turn determined based on historic pixel values i_{x,y,t} for a sampled set of pixels p_{x,y} in said images Iₜ.

In some embodiments,
the predicted pixel value \hat{μ}_{x,y,t} is determined as \hat{μ}_{x,y,t}=αμ_{x,y,t}+β, where α and β are constants determined so as to minimize Σ_{j,k}(i_{j,k,t}−(αμ_{j,k,t}+β))², where μ_{j,k,t} is said estimated projected future mean pixel value for the pixel p_{j,k} in question, and where j and k are iterated over a test set of pixels.

In some embodiments,
μ_{x,y,t} is an estimated historic mean with respect to pixel values i_{x,y,t} for the pixel p_{j,k} in question.

In some embodiments,
said test set of pixels contains between 1% and 25% of the total set of pixels p_{x,y} in the image Iₜ.

In some embodiments,
said test set of pixels is geometrically evenly distributed across the total set of pixels p_{x,y} in the image Iₜ.

In some embodiments,
the estimated standard deviation σ_{x,y,t} is determined according to

$${σ}_{x , y , t}^{2} = {σ}_{x , y , t - 1}^{2} ( 1 - ξ ) + {ξ ( {i}_{x , y , t} - {αμ}_{x , y , t} - β )}^{2} ,$$

where ξ∈]0,1[.

In some embodiments, the method further comprises
determining that at least one is true of α being further away from 1 than a first threshold value and β being further away from 0 than a second threshold value; and
determining the predicted pixel value, (\hat{μ}_{x,y,t}) according to any one of claims 14-18 until it is determined that α is no longer further away from 1 than the first threshold value and β is no longer further away from 0 than the second threshold value.

In some embodiments, the method further comprises
for said pixel values i_{x,y,t} for which said first value is higher than said second value, only store said information indicating that the pixel value i_{x,y,t} is part of a detected blob in case also the following inequality holds: B[i_{x,y,t}−\hat{μ}_{x,y,t}]²>\hat{μ}_{x,y,t}, where i_{x,y,t} is the pixel value in question, where \hat{μ}_{x,y,t} is the predicted pixel value and where B is an integer such that B>100.

In some embodiments, the method further comprises
using a Hoshen-Kopelman algorithm to group together individual adjacent pixels determined to be part of a same blob.

In some embodiments,
the objects are golf balls.

The invention can be embodied as a method for tracking moving objects, the method comprising:
obtaining a series of digital images I from a digital camera, the digital images I representing optical input from a three-dimensional space within a field of view of the digital camera over time, each of the digital images I having pixels p_{x,y} with corresponding pixel values i_{x,y};
performing, at a computer, image segmentation on each image of the series of digital images I using a statistical model of background for the optical input to detect blobs, wherein performing the image segmentation comprises, for each of two or more pixel values i_{x,y,t} in the image,
determining an inequality result using a current pixel value i_{x,y,t} for a pixel p_{x,y} in a current image Iₜ, first S_{x,y,t} and second Q_{x,y,t} values of the statistical model for the pixel p_{x,y}, and a confidence level value Z², wherein the first S_{x,y,t} and second Q_{x,y,t} values are calculated based on historic pixel values i_{x,y} from images from the series of digital images I before the current image Iₜ, each of the current pixel value i_{x,y,t}, the first S_{x,y,t} and second Q_{x,y,t} values, and the confidence level value Z² are stored as integer type data in a memory of the computer, and the determining uses integer operations in the computer, and
storing in the memory of the computer, information indicating that the current pixel value i_{x,y,t} for the image pixel in the current image Iₜ is part of a detected blob in response to the inequality result; and
using the stored information to correlate detected blobs across the series of digital images I to determine paths of moving objects through the three-dimensional space within the field of view of the digital camera.

Moreover, the invention can also be embodied as a system for tracking moving objects, the system comprising a digital camera, a digital image analyzer and a moving object tracker,
the digital camera being arranged to represent optical input from a three-dimensional space within a field of view of the digital camera to produce a series of digital images Iₜ at consecutive times t, the digital camera being arranged to produce said digital images Iₜ having a corresponding set of pixels p_{x,y}, said digital images comprising corresponding pixel values i_{x,y,t}, the digital camera being arranged to not move in relation to said three-dimensional space during production of said series of digital images (Iₜ);
the digital Image analyzer being configured to, for two or more of said pixel values i_{x,y,t}, determine an inequality comparing a first value to a second value, the first value being calculated as, or based on, the square of the difference between the pixel value i_{x,y,t} in question and a predicted pixel value \hat{μ}_{x,y,t}, the second value being calculated as, or based on, a product of, firstly, the square of a number Z and, secondly, an estimated variance or standard deviation σ_{x,y,t} with respect to historic pixel values i_{x,y,{t-n,t-1}} for the pixel p_{x,y} in question, where the predicted pixel value \hat{μ}_{x,y,t} is calculated based on historic pixel values i_{x,y,{t-n,t-1}} for the pixel p_{x,y} in question, and where Z is selected such that Z² is an integer such that 10≤Z²≤20;
the digital image analyzer being configured to, for pixel values i_{x,y,t} for which said first value is higher than said second value, store in a computer memory information indicating that the pixel value i_{x,y,t} is part of a detected blob; and
the moving object tracker being configured to correlate, based on the information stored in the computer memory, detected blobs across said series of digital images Iₜ to determine paths of moving objects through said three-dimensional space.

Furthermore, the invention can also be embodied as a computer software product configured to, when executing,
receive a series of digital images Iₜ from a digital camera, the digital camera being arranged to represent optical input from a three-dimensional space to produce said digital images Iₜ at consecutive times t, the digital camera being arranged to produce said digital images Iₜ having a corresponding set of pixels p_{x,y}, said digital images comprising corresponding pixel values i_{x,y,t}, the digital camera being arranged to not move in relation to said three-dimensional space during production of said series of digital images (Iₜ);
for two or more of said pixel values i_{x,y,t}, determine an inequality comparing a first value to a second value, the first value being calculated as, or based on, the square of the difference between the pixel value i_{x,y,t} in question and a predicted pixel value \hat{μ}_{x,y,t}, the second value being calculated as, or based on, a product of the square of, firstly, a number Z and, secondly, an estimated variance or standard deviation σ_{x,y,t} with respect to historic pixel values i_{x,y,{t-n,t-1}} for the pixel p_{x,y} in question, where the predicted pixel value \hat{μ}_{x,y,t} is calculated based on historic pixel values i_{x,y,{t-n,t-1}} for the pixel p_{x,y} in question, and where Z is selected such that Z² is an integer such that 10≤Z²≤20;
for pixel values i_{x,y,t} for which said first value is higher than said second value, store in a computer memory information indicating that the pixel value i_{x,y,t} is part of a detected blob; and
correlate, based on the information stored in the computer memory, detected blobs across said series of digital images Iₜ to determine paths of moving objects through said three-dimensional space.

The computer software product can be implemented by a non-transitory computer-readable medium encoding instructions that cause one or more hardware processors located in at least one of computer hardware devices in the system to perform the digital image processing and the object tracking.

### BRIEF DESCRIPTION OF THE DRAWINGS

In the following, the invention will be described in detail, with reference to exemplifying embodiments of the invention and to the enclosed drawings, wherein:

FIG. 1 is an overview of a system 100 configured to perform a method of the type illustrated in FIG. 3;

FIG. 2 is a simplified illustration of a data processing apparatus;

FIG. 3 shows a general flowchart for logically tracking moving target objects;

FIG. 4 is a flowchart of a method performed by the system 100 shown in FIG. 1;

FIG. 5 is an overview illustrating a noise model of a type described herein;

FIG. 6 shows an image frame illustrating a noise model;

FIG. 7 illustrates an example of clustering of pixels into blobs; and

FIG. 8 illustrates intensities for a pixel during a sudden exposure change event.

All figures share the same reference numerals for same and corresponding parts.

### DETAILED DESCRIPTION

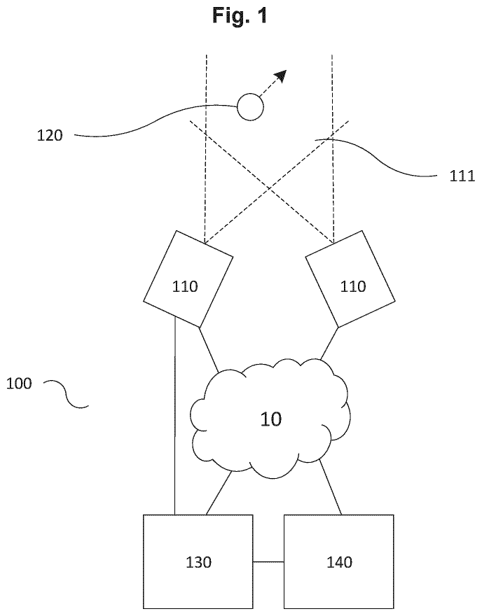

With reference to FIG. 1, the method relates to a method for tracking moving target objects 120. Generally, a system 100 can comprise one or several digital cameras 110, each being arranged to represent optical input from a three-dimensional space 111 within a field of view of the digital camera 110, to produce digital images of such moving target objects 120, the objects travelling through a space 111 hence being represented by the digital camera 110 in consecutive digital images. Such representation by the digital camera 110 will herein be denoted a “depiction”, for brevity.

The digital camera 110 is arranged to not move in relation to the space 111 during production of the series of digital images (Iₜ). For instance, the digital camera 110 may be fixed in relation to said space 111, or, in case it is movable it is kept still during the production of the series of digital images (Iₜ). Hence, the same part of the space 111 is depicted each time by the digital camera 110, and the digital camera 110 is arranged to produce digital images Iₜ having a corresponding set of pixels p_{x,y}, and so that said produced digital images Iₜ comprise corresponding pixel values i_{x,y,t}. “x” and “y” denote coordinates in an image coordinate system, whereas “t” denotes time.

That the pixel values i_{x,y,t} of two or more different images Iₜ “correspond” to each other means that individual pixels p_{x,y} measure light entering the camera 110 from the same, or substantially the same, light cone in all of the images Iₜ in question. It is realized that the camera 110 may move slightly, due to wind, thermal expansion and so forth, between images Iₜ, but that there is substantial correspondence between pixels p_{x,y} even in cases where such noise-inducing slight movement is present. There can be at least 50% overlap between light cones of any one same pixel p_{x,y} of the camera 110 between any two consecutive images Iₜ. There may also be cases where the camera 110 is movable, such as pivotable. In such cases an image transformation can be applied to a captured image so as to bring its pixels p_{x,y} into correspondence with pixels of a previous or future captured image.

In case the system 100 comprises more than one digital camera 110, several such digital cameras 110 can be arranged to depict the same space 111 and consequently tracking the same moving target object(s) 120 through said space 111. In such cases, the several digital cameras 110 can be used to construct a stereoscopic view of the respective tracked path of each target object 120.

As mentioned, the digital camera 110 is arranged to produce a series of consecutive images Iₜ, at different points in time. Such images may also be denoted image “frames”. In some embodiments, the digital camera 110 is a digital video camera, arranged to produce a digital moving film comprising or being constituted by such consecutive digital image frames.

As is illustrated in FIG. 1, the system 100 comprises a digital image analyzer 130, configured to analyze digital images received directly from the digital camera 110, or receive from the digital camera 110 via an intermediate system, in same or processed (re-formatted, compressed, filtered, etc.) form. The analysis performed by the digital image analyzer 130 can take place in the digital domain. The digital image analyzer 130 may also be denoted a “blob detector”.

The system 100 further comprises an object tracker 140, configured to track said moving target objects 120 across several of said digital images, based on information provided from the digital image analyzer 130. The analysis performed by the object tracker 140 can also take place in the digital domain.

In example embodiments, the system 100 is configured to track target objects 120 in the form of sports objects in flight, such as balls in flight, for instance baseballs or golf balls in flight. In some embodiments, the system 100 is used at a golf practice range, such as a driving range having a plurality of bays for hitting golf balls that are to be tracked using the system 100. In other cases, the system 100 can be installed at an individual golf range bay, or at a golf tee, and configured to track golf balls being struck from said bay or tee. The system 100 can also be a portable system 100, configured to be positioned at a location from which it can track said moving target objects 120. It is realized that the monitored “space” mentioned above will, in each of these and other cases, will be a space through which sport balls are expected to move.

Various types of computers can be used in the system 100. The digital image analyzer 130 and the object tracker 140 constitute examples of such computers. In some cases, the digital image analyzer 130 and the object tracker 140 can be provided as software functions executing on one and the same computer. The one or several digital cameras 110 can also be configured to perform digital image processing, and then also constitute examples of such computers. In some embodiments, the digital image analyzer 130 and/or the object tracker 140 is or are implemented as software functions configured to execute on hardware of one or several digital cameras 110. In other embodiments, the digital image analyzer 130 and/or the object tracker 140 is or are implemented on standalone or combined hardware platforms, such as on a computer server.

The one or several digital cameras 110, the digital image analyzer 130 and the object tracker 140 are configured to communicate digitally, either via computer-internal communication paths, such as via a computer bus, or via computer-external wired and/or wireless communication paths, such as via internet network 10 (e.g., the Internet). In implementations that need substantial communications bandwidth, the camera(s) 110 and the digital image analyzer 130 can communicate via a direct, wired digital communication route, which is not over the network 10. On the other hand, the digital image analyzer 130 and the object tracker 140 may communicate with each other over the network 10 (e.g., a conventional Internet connection).

The essential elements of a computer, in general, are a processor for performing instructions and one or more memory devices for storing instructions and data. As used herein, a “computer” can include a server computer, a client computer, a personal computer, embedded programmable circuitry, or a special purpose logic circuitry. Such computers can be connected with one or more other computers through a network, such as the internet 10, or via any suitable peer-to-peer connection for digital communications, such as a Bluetooth® connection.

Each computer can include various software modules, which can be distributed between an applications layer and an operating system. These can include executable and/or interpretable software programs or libraries, including various programs that operate, for instance, as the digital image analyzer 130 program and/or the object tracker 140 program. Other examples include a digital image preprocessing and/or compressing program. The number of software modules used can vary from one implementation to another and from one such computer to another. Each of said programs can be implemented in embedded firmware and/or as software modules that are distributed on one or more data processing apparatus connected by one or more computer networks or other suitable communication networks.

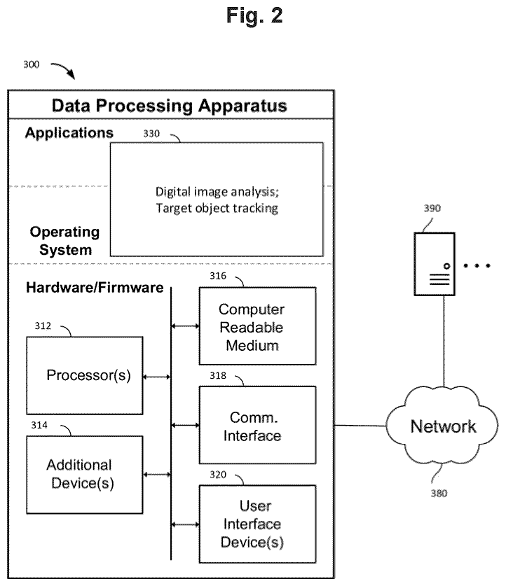

FIG. 2 illustrates an example of such a computer, being a data processing apparatus 300 that can include hardware or firmware devices including one or more hardware processors 312, one or more additional devices 314, a non-transitory computer readable medium 316, a communication interface 318, and one or more user interface devices 320. The processor 312 is capable of processing instructions for execution within the data processing apparatus 300, such as instructions stored on the non-transitory computer readable medium 316, which can include a storage device such as one of the additional devices 314. In some implementations, the processor 312 is a single or multi-core processor, or two or more central processing units (CPUs). The data processing apparatus 300 uses its communication interface 318 to communicate with one or more other computers 390, for example, over the network 380. Thus, in various implementations, the processes described can be run in parallel, concurrently, or serially, on a single or multi-core computing machine, and/or on a computer cluster/cloud, etc.

The data processing apparatus 300 includes various software modules, which can be distributed between an applications layer and an operating system. These can include executable and/or interpretable software programs or libraries, including a program 330 that constitutes the digital image analyzer 130 described herein, configured to perform the method steps performed by such digital image analyzer 130. The program 330 can also constitute the object tracker 140 described herein, configured to perform the method steps performed by such object tracker 140.

Examples of user interface devices 320 include a display, a touchscreen display, a speaker, a microphone, a tactile feedback device, a keyboard, and a mouse. Moreover, the user interface device(s) need not be local device(s) 320, but can be remote from the data processing apparatus 300, e.g., user interface device(s) 390 accessible via one or more communication network(s) 380. The user interface device 320 can also be in the form of a standalone device having a screen, such as a conventional smartphone being connected to the system 100 via a configuration or setup step. The data processing apparatus 300 can store instructions that implement operations as described in this document, for example, on the non-transitory computer readable medium 316, which can include one or more additional devices 314, for example, one or more of a floppy disk device, a hard disk device, an optical disk device, a tape device, and a solid state memory device (e.g., a RAM drive, a Flash memory or an EEPROM). Moreover, the instructions that implement the operations described in this document can be downloaded to the non-transitory computer readable medium 316 over the network 380 from one or more computers 390 (e.g., from the cloud), and in some implementations, the RAM drive is a volatile memory device to which the instructions are downloaded each time the computer is turned on.

It is realized that the described computer hardware can be physical hardware, virtual hardware or any combination thereof.

As mentioned, the system 100 is configured to perform a method according to one or more embodiments for optically tracking moving target objects 120.

The present invention can furthermore be embodied as a computer software product, configured to perform said method when executing on computer hardware of the type described herein. The computer software product can hence be deployed as a part of the system 100 so as to provide the functionality required to perform the present method.

Both said system 100 and said computer software product are hence configured to track moving target objects 120 moving through said space 111 in relation to one or several digital cameras 110, by comprising or embodying the above-mentioned digital image analyzer 130 and object tracker 140, in turn being configured to perform the corresponding method steps described herein.

In general, everything that is said in relation to the presently described method is equally applicable to the system 100 and to the computer software product described herein, and vice versa.

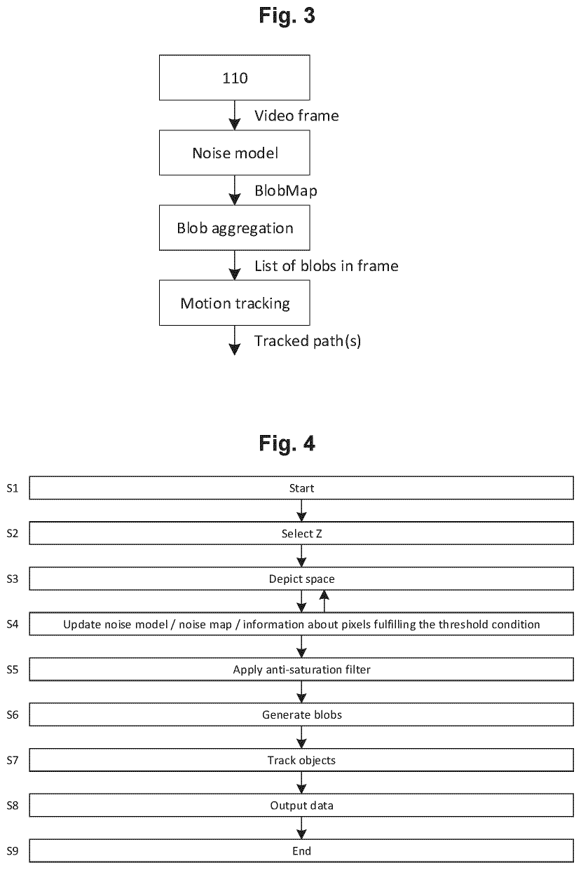

FIG. 3 illustrates a general flowchart for tracking moving target objects 120 based on digital image information received from one or several digital cameras 110.

In computer vision, “image segmentation” is the process of separating an image into different regions, representing target objects within it. Generally, it is desirable to distinguish potential moving target objects from a background. The background may in general be changing and noisy, and is in many cases quite unpredictable. In the example of a golf ball, for instance, when such a ball is far away from the digital camera 110 depicting the ball 120, it may be even as small as one single pixel p_{x,y} in the digital image frame produced by the digital camera 120.

For these reasons, it is in general not possible to separate out a foreground object 120 from a background based only on a detected shape in relation to an expected shape of the target object 120. Instead, it is proposed to set up a statistical model of the background (in the following denoted a “noise model”), and to identify pixels p_{x,y} that by a probability measure deviate from an expected value with more than a threshold value, based on this model. Adjacent pixels p_{x,y} in the detected digital image that deviate from the expected value in accordance with the model are grouped together into a “blob” of pixels p_{x,y} (“blob aggregation”).

Such a method may result in a very large number of false positives, such as about 99.9% false positives. However, a subsequent motion tracking analysis can sort out the vast majority of all false positives, such as only keeping blobs that seem to obey Newton's laws of motion between consecutive digital image frames Iₜ.

The noise model step, as depicted in FIG. 3, is used to suppress noise in the image frames, with the purpose of lowering the number of detected blobs in the subsequent blob aggregation step. The noise model analyzes a plurality of pixels p_{x,y}, such as every pixel p_{x,y}, in said image frames Iₜ, and is therefore at risk of becoming a major bottleneck. These calculations, aiming to identify noise that does not conform to a detected statistical pattern in order to identify outliers, can be handled by high-performance GPUs (Graphics Processing Units), but performance may still prove to be a problem. The approach described herein has turned out to drastically reduce the computational power required per pixel p_{x,y} in a moving target object 120 tracking system 100. This reduction can be exploited by using simpler hardware, lower power consumption or a larger incoming image bitrate.

Turning now to FIG. 4, a method according to one or more embodiments is illustrated.

In a first step S1, the method starts.

In a subsequent step S2, a number Z is selected such that Z² is an integer. The number Z can be selected such that Z² is an integer such that 10≤Z²≤20. It is noted that Z may be a non-integer, as long as Z² is an integer value. This step S2 may be performed ahead of time, such as during a system 100 design process or a system 100 calibration step.

In a subsequent step S3, the space 111 is depicted using the digital camera 110 to produce a series of digital images it at consecutive times t. The space 111 can be depicted using the digital camera 110 to produce a series of N digital images it at consecutive times t. However, it is realized that the procedure can also be a continuous or semi-continuous procedure, wherein the digital camera 110 will continue to produce digital images it at consecutive times t so long as the procedure is ongoing. Hence, in this case the number of digital images N will grow by 1 for each captured frame. In either case, the series of digital images it at consecutive times t may be seen as a stream of digital images captured much like a digital video stream.

In a subsequent step S4, for two or more (e.g., several) of said pixel values i_{x,y,t}, an inequality is determined, involving comparing a first value to a second value.

The first value is calculated based on the square of the difference between the pixel value i_{x,y,t} in question and a calculated predicted pixel value \hat{μ}_{x,y,t} for that pixel p_{x,y}. The second value is calculated based on a product of, on the one hand, the square of the selected number Z, this square then being an integer value, and, on the other hand, an estimated variance or standard deviation σ_{x,y,t} with respect to historic pixel values i_{x,y,{t-n,t-1}} for the pixel p_{x,y} in question. Concretely, the second value can be calculated based on said estimated variance or a square of the estimated standard deviation σ_{x,y,t}.

The predicted pixel value \hat{μ}_{x,y,t} is also calculated based on historic pixel values i_{x,y,{t-n,t-1}} for the pixel p_{x,y} in question, in other words using information from image frames I_{t-Δt} captured by the camera 110 at points in time prior to the time t. The predicted pixel value \hat{μ}_{x,y,t} can be calculated based on the same, or different, set of historic pixel values i_{x,y,{t-n,t-1}} as the estimated variance or standard deviation σ_{x,y,t}.

In the notation used herein, “n” denotes the number of historic pixel values i_{x,y,t}, considered by the noise model, counting backwards from the currently considered image frame. This notation hence assumes that the same consecutive pixel values i_{x,y,t}, up to the presently considered image frame, are used to calculate both the first and the second value, but it is realized that any suitable contiguous or non-contiguous, same or different, intervals of pixel values i_{x,y,t} can be used to calculate the first and the second value, respectively.

In general, the equations and expressions disclosed and discussed herein are provided as illustrative examples, and it is realized that in practical embodiments they can be tailored to specific needs. This can include, for instance, the introduction of various constant factors and scaling factors; additional intermediate calculation steps, such as filtering steps; and so forth.

In some embodiments, said inequality may be written as:

$${( {i}_{x , y , t} - {\hat{μ}}_{x , y , t} )}^{2} > {Z}^{2} {σ}_{x , y , t}^{2} ,$$

where \hat{μ}_{x,y,t} is said predicted pixel value and where σ_{x,y,t} is an estimated standard deviation with respect to said historic pixel values i_{x,y,{t-n,t-1}} for the pixel p_{x,y} in question.

In general, the presently described noise model can be configured to, for each pixel p_{x,y}, estimate a moving average and standard deviation based on the last n image frames, and then to use these metrics to decide whether the pixel value i_{x,y,t} in the same image location in the new frame deviates from the expected value more than an allowed limit.

This model can be designed to assume that any pixel in the background of the considered image it has an intrinsic Gaussian noise, as long as the background only contains features that are assumed to be static in the first approximation. A normal distribution can be used to establish a suitable confidence interval. For instance, if a Z score of 3.464 is used, it can be seen that 99.95% of all samples with no significant differences from the background fall within the corresponding confidence interval. Therefore, a pixel p_{x,y} with signal value i_{x,y} at time t is considered to have a significant difference from the background if:

$$\frac{\vert {i}_{x , y , t} - {μ}_{x , y} \vert}{{σ}_{x , y}} > Z , where {μ}_{x , y} \approx {ι}_{x , y} = \frac{{\sum }_{k} {i}_{x , y , k}}{n} . \qquad ( 1 )$$

Here, k iterates over the previous n frames. The limit is based on the (uncorrected) standard deviation:

$$σ = \sqrt{\frac{\sum {( {i}_{x , y , t} - μ )}^{2}}{n}} .$$

The corrected (unbiased) standard deviation would be a mathematically more correct choice, i.e. a more accurate estimate of σ would result from dividing by n−1 rather than by n. However, for the present purposes this is not significant, since the limit used is a multiple of the standard deviation that may be freely selected. Selecting the number n of previous image frames considered for the estimation of the standard deviation in the second value (used in evaluating said inequality) to be a power of 2 (e.g. 16, 32, 64, . . . ), we can get computationally efficient multiplications and divisions at a very low cost, by using shifting operations.

When processing an image frame Iᵢ, pixel values i_{x,y} from frames k∈[t−n, t−1] are used. A variant of the formula for computing the standard deviation that allows for it to be computed in a single pass is the following. Here the expression for the estimate of the mean is also provided:

$${σ}_{x , y , t} = \sqrt{\frac{n {\sum }_{k} {i}_{x , y , k}^{2} - {( {\sum }_{k} {i}_{x , y , k} )}^{2}}{{n}^{2}}} \qquad ( 2 )$$

$${μ}_{x , y , t} = \frac{{\sum }_{k} {i}_{x , y , k}}{n} \qquad ( 3 )$$

Set

$${Q}_{x , y , t} = {\sum }_{k} {i}_{x , y , k}^{2} and {S}_{x , y , t} = {\sum }_{k} {i}_{x , y , k} ,$$

and the expressions (2) and (3) can then be rewritten as:

$${σ}_{x , y , t} = \sqrt{\frac{{nQ}_{x , y , i} - {S}_{x , y , i}^{2}}{{n}^{2}}} \qquad ( 4 )$$

$${μ}_{x , y , t} = \frac{{S}_{x , y , t}}{n} \qquad ( 5 )$$

Revisiting (1), it is safe to square both sides, since both the left-hand and right-hand sides of this equation are non-negative:

$${( {i}_{x , y , t} - {μ}_{x , y , t} )}^{2} > {Z}^{2} {σ}_{x , y , t}^{2} . \qquad ( 6 )$$

Combining (4) and (6) yields:

$${( {i}_{x , y , t} - \frac{{S}_{x , y , t}}{n} )}^{2} > {Z}^{2} \frac{{nQ}_{x , y , t} - {S}_{x , y , t}^{2}}{{n}^{2}} . \qquad ( 7 )$$

This is equivalent to:

$${( {ni}_{x , y , t} - {S}_{x , y , t} )}^{2} > {Z}^{2} ( {nQ}_{x , y , t} - {S}_{x , y , t}^{2} ) . \qquad ( 8 )$$

Iₜ is noted that n≤N. Hence, the above-discussed inequality can be expressed as (8), with

$${S}_{x , y , t} = {\sum }_{j = t - n}^{t - 1} {i}_{x , y , j} ; and {Q}_{x , y , t} = {\sum }_{j = t - n}^{t - 1} {i}_{x , y , j}^{2} .$$

Since i_{x,y,t}, n, S_{x,y,t} and Q_{x,y,t} are all integers, and since Z can be picked to produce an appropriate or desired number of false positives, the entire calculation can be done using only integer numbers. This means that the calculations can be performed without any loss of precision due to floating point truncation errors. Also, integer operations are typically faster than their floating-point counterparts.

In the following table, various outcomes for different selected values of Z are shown:

| Z² | Z | P (number of false positives, ppm) |
|---|---|---|
| 12 | 3.46410 | 532.1 |
| 13 | 3.60555 | 311.6 |
| 14 | 3.75166 | 175.7 |
| 15 | 3.87298 | 107.6 |
| 16 | 4.00000 | 63.4 |

Equation (8) depends on knowledge of the sum S and the squared sum Q of the last n observations of the pixel value i_{x,y,t} in question:

$${S}_{x , y , t} = {\sum }_{j = t - n}^{t - 1} {i}_{x , y , j} \qquad ( 9 )$$

$${Q}_{x , y , t} = {\sum }_{j = t - n}^{t - 1} {i}_{x , y , j}^{2} . \qquad ( 10 )$$

While it would be possible to calculate the statistics using (9) and (10) directly, for each pixel value i_{x,y,t} of each frame Iₜ, it is much more computationally efficient to use a recursive definition, where in every step the new frame Iₜ is added to the noise model, and the frame Iₜ₋ₙ from n frames back is removed:

$${S}_{x , y , t} = {\sum }_{j = t - n}^{t - 1} {i}_{x , y , j} = {S}_{x , y , t - 1} + {i}_{x , y , t} - {i}_{x , y , t - n} \qquad ( 11 )$$

$${Q}_{x , y , t} = {\sum }_{j = t - n}^{t - 1} {i}_{x , y , j}^{2} = {Q}_{x , y , t - 1} + {i}_{x , y , t}^{2} - {i}_{x , y , t - n}^{2} \qquad ( 12 )$$

Updating Q_{x,y,t} requires two multiplications to generate the squares. However, since Q_{x,y,t} involves a difference of squares, it can be reduced to one single multiplication if rewritten as follows:

Q_{x,y,t}=Q_{x,y,t-1}+(i_{x,y,t}+i_{x,y,t-n})(i_{x,y,t}−i_{x,y,t-n}). (13)

Define z₋=i_{x,y,t}−i_{x,y,t-n} and z₊=i_{x,y,t}+i_{x,y,t-n}. Then:

S_{x,y,t}=S_{x,y,t-1}+z₋; and (14)

Q_{x,y,t}=Q_{x,y,t-1}+z₊z₋. (15)

(14) and (15) are then the full calculations required to update the noise model. A straightforward implementation would require only 3 (int) additions, 1 (int) subtraction and 1 (int) multiplication per pixel, which makes it very computationally efficient. Furthermore, these calculations can be accelerated by use of SIMD instructions sets such as AVX2 (on x86_64) or NEON (on aarch64), or they can be run on a GPU or even implemented on an FPGA.

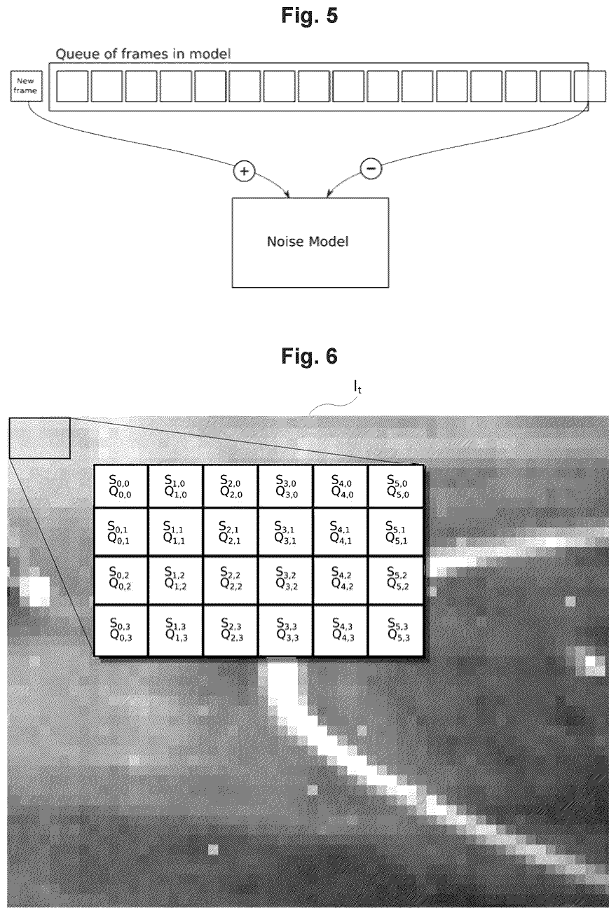

The calculations performed to update the noise model between consecutive image frames Iₜ are conceptually illustrated in FIG. 5, showing how the “New frame” Iₜ is added to the Noise Model, and a frame Iₜ-n from n frames back, such as the last frame in the currently considered “Queue of frames in model” is removed. As has been described above, this can be performed efficiently by considering the individual pixel values i_{x,y,t} and i_{x,y,t-n}, calcuting the value of z₊ and z₋.

From the above it is clear that 0≤S≤2^{b}n and 0≤S≤2^{b}n, where b is the bit depth of the input pixel value i_{x,y,t} data. In some embodiments, n is not more than 300, or not more than 256, or not more than 128, and such as not more than 64=2⁶ (the averaging is not performed over more than 64 consecutive image frames Iₜ). In some embodiments, n can be as low as 32, or even as low as 16 or even 10. In some embodiments, the n frames considered at each point in time are the n latest frames captured and provided by the camera 110. In this case, the n frames can together cover a time period of between 0.1 s and 10 s, such as between 0.5 s and 2 s, of captured video. In other words, the number of considered frames n can be relatively close to a frame rate used by the digital camera 110. The noise model may then be required to store two integers per pixel p_{x,y}, in addition to keeping the actual image frames in memory for at least as many frames Iₜ as the length of the window size n. Furthermore, an additional single-precision float may be required per pixel to store the estimated variance if the calculation (as described in equation (19), below) is used.

In some embodiments, the pixel values i_{x,y,t} have a bit depth across one or several channels of between 8 and 48 bits, such as a single channel (for instance a gray channel) of 8 or 16 bit depth or three channels (such as RGB) of 16 or 24 bit depth.

In case the camera 110 provides pixel value i_{x,y,t} information across several color channels, the pixel values i_{x,y,t} can be transformed into a single-channel (such as a gray scale channel) before processing of the pixel values i_{x,y,t} by the digital image analyzer 130. Alternatively, only one such channel, out of several available channels, can be used for the analysis. Further alternatively, several channels can be analyzed separately and in parallel, so that a pixel that is detected to be a blob in at least one such analyzed channel is determined to be a blob at any point in time.

The transformed pixel values i_{x,y,t} can have a bit depth of at least 8 bits, and in some embodiments at the most 24 bits, such as at the most 16 bits. A bit depth of 12 bits has proven to strike a reasonable balance between speed, memory requirements and output quality. In case input data has a higher bit depth than required, the data from the camera 110 can be transformed (down-sampled) before processing by the digital image analyzer 130.

More generally, the number of bits required can be found for S as D+log₂(n) and for Q as 2D+log₂(n), where D is a bit depth for one single considered channel.

The following table shows the required storage space for S and Q depending on the used pixel value i_{x,y,t} bit depth when n=64:

| Pixel bit depth | S required bits | Q required bits |
|---|---|---|
| 8 | 14 (uint16) | 22 (uint32) |
| 10 | 16 (uint16) | 26 (uint32) |
| 12 | 18 (uint32) | 30 (uint32) |
| 16 | 22 (uint32) | 38 (uint64) |

In general, the method can comprise a step in which the noise model is updated and stored in computer memory, as a collection of updated noise model information (S and Q) with respect to individual pixels p_{x,y} for which blob detection is to be performed. This noise map can hence be updated and stored for each pixel p_{x,y} in the image.

Using the above-explained calculations, it is possible to store, in said computer memory, updated values for S_{x,y,t} and Q_{x,y,t} in combination as a single datatype (such as a single structure, record or tuple), the datatype comprising 12 bytes or less, or 10 bytes or less, or even 8 bytes or less, per pixel p_{x,y}. This storing, for each analyzed pixel value i_{x,y,t} (such as for all pixels p_{x,y} in the image Iₜ), of updated values for S_{x,y,t} and Q_{x,y,t} in combination as a single datatype, constitutes an example of the “noise model” described herein. Hence, the noise model is updated for each analyzed digital image frame Iₜ, such as for each individual image frame Iₜ in the set of consecutive image frames Iₜ produced and provided by the (each) digital camera 110.

In the same step S4, for pixel values i_{x,y,t} for which said first value is found to be higher than said second value, information is stored in said computer memory, the information indicating that the pixel value i_{x,y,t} is part of a detected blob.

This storing can take place in a generated pixmap, in other words a data structure having such indicating information for each pixel p_{x,y}. The information for each pixel p_{x,y} that it belongs or does not belong to a blob for that image frame Iₜ can be stored very computationally efficient, since it can be stored as a single binary bit.

One way of implementing such a pixmap in practice is to use a “noise map” of the general type that will be described in the following, where the pixmap also comprises, for each pixel p_{x,y}, a value indicating an expected pixel value i_{x,y,t} for that pixel p_{x,y}.

Hence, for each frame, the noise model established as described above can be used to generate such a noise map, that for every pixel position p_{x,y} provides information about whether or not that particular pixel value i_{x,y,t} in the new frame Iₜ was outside of the allowed limits (that is, if (6) or (8) was true). In addition, the noise map can store an expected signal value for each pixel p_{x,y} at time t, such as based on the calculations performed in the determination of the noise model. The expected signal value is useful in downstream calculations, such as in a subsequent blob aggregation step, and so it is computationally efficient to establish and store this information already at this point.

FIG. 6 illustrates the noise model after being updated based on the information of a most recently available image frame Iₜ, and in particular how the frame Iₜ relates to the values of S_{x,y} and Q_{x,y} for that time t.

Even though it would be possible to first emit the noise map for each new image frame Iₜ arriving at the digital analyzer 130, and only thereafter to update the noise model in the digital analyzer 130, both of them can be done in one go, without unloading or overwriting the information in memory between said calculations. Hence, the (each) new image frame Iₜ is loaded into the CPU memory; and z₊, z₋, S_{x,y,t}, Q_{x,y,t}, σ_{x,y,t} and/or μ_{x,y,t} are calculated for each pixel p_{x,y}, as the case may be, before the loaded data is unloaded or overwritten in the CPU memory. The advantage achieved then is to avoid memory access becoming a bottleneck. Once the penalty of loading the data into the CPU has been paid, all the necessary calculations are performed before unloading or overwriting the data in the CPU memory.

In the following example, the noise map requires 16 bits per pixel p_{x,y} to store. This information can be stored in a single two-byte datatype (such as an uint16).

The information indicating whether or not the pixel p_{x,y} corresponding to each noise map entry is a blob pixel or not can be stored in the form of one single bit out of the total number of stored bits for the pixel p_{x,y} in question in the noise map. In some embodiments, the most significant bit in datatype used to store noise map data for each pixel p_{x,y}, such as the most significant bit in the exemplifying two-byte structure, indicates whether the pixel value i_{x,y,t} in question is outside the blob generating limits. Then, the lower 15 bits can encode the expected (average) pixel value i_{x,y} signal, scaled to 15 bits precision and can be stored in fixed-point representation. It is noted that this expected pixel value i_{x,y} signal corresponds to the above-discussed predicted pixel value \hat{μ}_{x,y,t}. In other words, the value in the noise map indicating an expected pixel value i_{x,y,t} for the pixel p_{x,y} can be achieved by transforming (if necessary) the predicted pixel value \hat{μ}_{x,y,t} to a grayscale bit depth of 15 bits.

In one example, the encoding is according to the following, for performance reasons: First, the expected signal is scaled to 15 bits (0 . . . 32767). If n=32 and the input pixel depth is 12 bits, this means that St uses 17 bits for each pixel value i_{x,y,t}. A simple shift operation will divide this number by 4, which puts it in the 15 bit range. Secondly, if the pixel value i_{x,y,t} is within the limits given in equation (6) (or as given in its reformulated form (8)), all bits are negated. A noise map consumer can therefore iterate through the pixels p_{x,y} of the noise map data and ignore all entries that have the most significant bit set to 1.

It should be noted that the pixmap for each pixel at least or only contains information on 1) whether that pixel is part of a blob and 2) the predicted pixel value for that pixel. In this case, the prediction is simply the arithmetic mean of the previous n frames, but we will, later on, describe a method, which can be an alternative method to the one described so far, to predict the value to be used when the recent frames have large changes in capture parameters such as shutter time or gain.

In some embodiments, the stored noise model incorporates all available information from image frames Iₜ received to the digital image analyzer 130 from the camera 110. In other words, it can use n consecutive or non-consecutive image frames Iₜ up until a most recently received image frame Iₜ to calculate values for Q_{x,y} and S_{x,y}. On the other hand, the estimated projection (predicted pixel value \hat{μ}_{x,y,t}) data stored for each pixel p_{x,y} in the noise map can be updated only using a second-to-most recently received image frame Iₜ, i.e. not using a most recently received image frame Iₜ that contains the pixel values i_{x,y,t} to be assessed with respect to blob classification. In practice, this may mean that the previous values for S_{x,y,t}, before being updated using the most recently received pixel values i_{x,y,t}, can be used to calculate the (transformed) predicted data which is then stored in the pixmap.

In the above example, the predicted pixel value \hat{μ}_{x,y,t} is determined as (or at least based on) an estimated projected future mean pixel value μ_{x,y,t}, in turn determined based on historic pixel values i_{x,y,t} for a sampled set of pixels p_{x,y} in said sequence of image frames Iₜ.

In embodiments that will be described in more detail in the following, the predicted pixel value \hat{μ}_{x,y,t} is determined as \hat{μ}_{x,y,t}=αμ_{x,y,t}+β, where α and β are constants determined so as to minimize the expression

Σ_{j,k}(i_{j,k,t}−(αμ_{j,k,t}+β))², (16)

where μ_{j,k,t} is said estimated projected future mean pixel value for the pixel p_{j,k} in question, and where j and k are iterated over a test set of pixels p_{x,y} in the image frame Iₜ. The determination of α and β can take place in any per se conventional manner, which is well within the reach of the skilled person. As is the case for the above-described noise model, in some embodiments, μ_{x,y,t} can be an estimated historic mean with respect to pixel values i_{x,y,t} for the pixel p_{j,k} in question.

The above-described pure variance based noise model has proven to give good results in a wide range of environments. However, if the light conditions in the image change too quickly, the noise map will be flooded with outliers at first. In the image frames Iₜ that follow upon such changed light conditions, the standard deviation estimate will be in inflated, which instead leads to some degree of blindness until the noise model stabilizes again.

The suitability of different variants of the presently described method can also vary depending on the camera 110 hardware used. For instance, exposure and gain can be more or less coarse for different types of cameras, and aperture changes can be performed more or less quickly.

It is then proposed to estimate a linear mapping between the average intensity value in the noise model and the pixel intensities in the new frame. That is, find values for variables α and β that minimize (16).

In (16), j may represent a sample or test set of pixels p_{x,y}, such as a set of pixels p_{x,y} evenly distributed (geometrically) pixel positions in the image frame Iₜ.

To be clear, when establishing the coefficients α and β, pixels p_{x,y} from different positions in the same image frame Iₜ are considered, and such pixels p_{x,y} are compared with their corresponding positions in the noise model data.

In some embodiments, said test set of pixels p_{x,y} can contain at least 0.1%, such as at least 1%, such as at least 10%, of the total set of pixels p_{x,y} in the image Iₜ. In some embodiments, said test set of pixels p_{x,y} can contain at most 80%, such as at most 50%, such as at most 25%, such as at most 10%, of the total set of pixels p_{x,y} in the image Iₜ. The test set of pixels p_{x,y} can be geometrically evenly distributed across the total set of pixels p_{x,y} in the image Iₜ. For instance, the set can form a uniform sparse pattern extending across the entire image Iₜ, or extending across at least 50% of the image Iₜ; or the set can form a sparsely but evenly distributed set of vertical and/or horizontal full or broken lines distributed across the entire image Iₜ, or at least 50% of the image Iₜ. In some embodiments, pixels that are overexposed are not included in the test set. This can be determined by comparing the pixel values to a known threshold value, often provided by the sensor manufacturer. If it is not known, the threshold value can easily be established experimentally.

Next, the equation for checking the limits (that is, (6) above or an equivalent formulation of this equation), is updated according to the following:

$${( {i}_{x , y , t} - {\hat{μ}}_{x , y , t} )}^{2} > {Z}^{2} {σ}_{x , y , t}^{2} . \qquad ( 17 )$$

$${\hat{μ}}_{x , y , t} = {αμ}_{x , y , t} + β . \qquad ( 18 )$$

Also, since the variance

$${σ}_{x , y , t}^{2}$$

changes over time, the variance estimate needs to be updated as well. It is unfortunately not feasible to use the value from (4), since it will be inflated by the exposure change that is already compensated for by using \hat{μ}_{x,y,t} as explained above. Instead, it is updated by weighing in the current squared deviation:

$${σ}_{x , y , t}^{2} = {σ}_{x , y , t - 1}^{2} ( 1 - ξ ) + {ξ ( {i}_{x , y , t} - {αμ}_{x , y , t} - β )}^{2} , where ξ ∈ ] 0 , 1 [ . \qquad ( 19 )$$

ξ∈]0,1[ is the factor that decides how much weight should be given to this deviation compared to the existing value. The higher ξ, the faster the noise model will adapt to fluctuations.

These combined, together with observing that if we apply a scaling factor α to the input, the variance can be scaled appropriately:

$${( {i}_{x , y , t} - {αμ}_{x , y , t} - β )}^{2} > {Z}^{2} {α}^{2} {σ}_{x , y , t}^{2} . \qquad ( 20 )$$

This variant of the noise model requires

$${σ}_{x , y , t}^{2}$$

to be stored in an array, typically with one single-precision float (32 bits) per pixel p_{x,y}. As comparison, the pure variance noise model stores (indirectly, by storing S and Q that allows for calculation of

$${σ}_{x , y , t}^{2}$$

as described above) the estimated variance

$${σ}_{x , y , t}^{2}$$

for each pixel p_{x,y} when run. When this linear mapping model is used,

$${σ}_{x , y , t}^{2}$$

is updated using (19). Since the definition is recursive, the variance of this pixel in the previous frame will either be calculated from S and Q or from the previous iteration's calculation of (19) for this pixel. The sums S_{x,y,t} and square-sums Q_{x,y,t} still need to be updated for every image frame Iₜ, in order to have the numbers available as soon as the step effect has passed.

To illustrate the case when the predicted pixel value is determined as \hat{μ}_{x,y,t}=αμ_{x,y,t}+β, an example will now be provided as illustrated in FIG. 8. In the chart shown therein, the Y axis shows pixel intensity i_{x,y,t} for one particular pixel p_{x,y} i in a sequence of consecutive digital image frames Iₜ. The X axis depicts frame numbers. The window size n=32, which means that during the first 32 frames, the model is still being initialized. Once 32 frames have been processed, the model contains sufficient information to make predictions of expected mean μ_{x,y,t} and

$${σ}_{x , y , t}^{2} .$$

The line AVG shows the rolling average of the last 32 frames, which is the predictor determined according to (5).

As can be seen in the graph, the true signal value fluctuates around 2021 from the start until frame #60, where there is a sudden change in exposure time. The exposure times used can be provided as a part of the frame” metadata. If the exposure time in the new frame differs significantly from the exposure times of the recent frames, the method described in connection to (17)-(19) should be used, since the levels have shifted and the model will be contaminated while this is happening.

As can also be seen on the graph, it takes 32 frames for μ_{x,y,t} to fully stabilize on the new level. Until that point is reached, μ_{x,y,t} is not a particularly good predictor, since it is lagging behind. In order to compensate for this, the rolling average goes through a linear transformation according to (18). This outcome is shown as “Adj AVG” in the graph. It can clearly be seen that this corresponds much better to the pixel values.

Similarly, as can be seen in the following table (corresponding to the graph in FIG. 8), the variance

$${σ}_{x , y , t}^{2}$$

is somewhere around 250 before the exposure change, whereas it gets inflated all the way up to 4200 while the model is adapting. This is why the variance update method according to (19) is put into use. When processing frame 60, it first transforms the average value μ_{x,y,t} to \hat{μ}_{x,y,t} using the linear mapping. It calculates the new pixel value's i_{x,y,t} deviation from \hat{μ}_{x,y,t} and decides whether it is outside the limits, according to (20). If this is the first frame where the exposure change was noticed, the variance

$${σ}_{x , y , t - 1}^{2}$$

of the previous frame is used. This is initially based on S and Q (as determined according to the above), but is useful since S and Q still only includes pixel values i_{x,y,t} from before the exposure change.

Finally, the

$${σ}_{x , y , t + 1}^{2}$$

to be use for the next frame is calculated according to (19). Below, #=Frame number; PV=Pixel Value; AVG=AVG; AAVG=Adj AVG.

| # | PV | AVG | AAVG |
|---|---|---|---|
| 1 | 2001 | | |
| 2 | 2006 | | |
| 3 | 2017 | | |
| 4 | 2016 | | |
| 5 | 2016 | | |
| 6 | 2000 | | |
| 7 | 2033 | | |
| 8 | 2026 | | |
| 9 | 1984 | | |
| 10 | 2023 | | |
| 11 | 2043 | | |
| 12 | 2016 | | |
| 13 | 2012 | | |
| 14 | 2024 | | |
| 15 | 2006 | | |
| 16 | 2012 | | |
| 17 | 2048 | | |
| 18 | 2031 | | |
| 19 | 2013 | | |
| 20 | 2030 | | |
| 21 | 2014 | | |
| 22 | 2009 | | |
| 23 | 2000 | | |
| 24 | 2017 | | |
| 25 | 2024 | | |
| 26 | 2032 | | |
| 27 | 2023 | | |
| 28 | 2029 | | |
| 29 | 1994 | | |
| 30 | 2027 | | |
| 31 | 2033 | | |
| 32 | 2018 | | |
| 33 | 2039 | 2019 | |
| 34 | 2023 | 2020 | |
| 35 | 2017 | 2020 | |
| 36 | 2044 | 2021 | |
| 37 | 2043 | 2021 | |
| 38 | 2046 | 2023 | |
| 39 | 2039 | 2023 | |
| 40 | 2035 | 2023 | |
| 41 | 2038 | 2025 | |
| 42 | 2029 | 2025 | |
| 43 | 2035 | 2025 | |
| 44 | 2010 | 2025 | |
| 45 | 2030 | 2025 | |
| 46 | 2007 | 2025 | |
| 47 | 2027 | 2026 | |
| 48 | 2030 | 2026 | |
| 49 | 2060 | 2026 | |
| 50 | 2055 | 2027 | |
| 51 | 2022 | 2027 | |
| 52 | 2026 | 2027 | |
| 53 | 2004 | 2027 | |
| 54 | 1985 | 2026 | |
| 55 | 2023 | 2027 | |
| 56 | 2022 | 2027 | |
| 57 | 2006 | 2027 | |
| 58 | 2023 | 2026 | |
| 59 | 2030 | 2027 | 2027 |
| 60 | 2160 | 2031 | 2155 |
| 61 | 2155 | 2036 | 2156 |
| 62 | 2142 | 2039 | 2156 |
| 63 | 2137 | 2043 | 2155 |
| 64 | 2168 | 2047 | 2156 |
| 65 | 2151 | 2051 | 2155 |
| 66 | 2114 | 2054 | 2154 |
| 67 | 2151 | 2058 | 2154 |
| 68 | 2154 | 2061 | 2153 |
| 69 | 2141 | 2064 | 2152 |
| 70 | 2154 | 2068 | 2152 |
| 71 | 2168 | 2072 | 2152 |
| 72 | 2142 | 2075 | 2151 |
| 73 | 2143 | 2078 | 2150 |
| 74 | 2160 | 2082 | 2150 |
| 75 | 2155 | 2086 | 2150 |
| 76 | 2136 | 2090 | 2150 |
| 77 | 2173 | 2095 | 2151 |
| 78 | 2183 | 2100 | 2152 |
| 79 | 2144 | 2104 | 2152 |
| 80 | 2152 | 2107 | 2152 |
| 81 | 2120 | 2109 | 2149 |
| 82 | 2159 | 2113 | 2149 |
| 83 | 2152 | 2117 | 2149 |
| 84 | 2156 | 2121 | 2149 |
| 85 | 2119 | 2124 | 2148 |
| 86 | 2160 | 2130 | 2150 |
| 87 | 2131 | 2133 | 2149 |
| 88 | 2175 | 2138 | 2150 |
| 89 | 2149 | 2142 | 2150 |
| 90 | 2158 | 2147 | 2151 |
| 91 | 2176 | 2151 | 2151 |
| 92 | 2157 | 2151 | |
| 93 | 2154 | 2151 | |
| 94 | 2152 | 2151 | |
| 95 | 2153 | 2152 | |
| 96 | 2141 | 2151 | |
| 97 | 2151 | 2151 | |
| 98 | 2144 | 2152 | |
| 99 | 2184 | 2153 | |
| 100 | 2158 | 2153 | |
| 101 | 2131 | 2153 | |
| 102 | 2112 | 2152 | |
| 103 | 2157 | 2151 | |
| 104 | 2155 | 2152 | |
| 105 | 2155 | 2152 | |
| 106 | 2155 | 2152 | |
| 107 | 2149 | 2152 | |
| 108 | 2158 | 2152 | |
| 109 | 2113 | 2150 | |
| 110 | 2119 | 2148 | |
| 111 | 2120 | 2148 | |
| 112 | 2132 | 2147 | |
| 113 | 2154 | 2148 | |
| 114 | 2162 | 2148 | |
| 115 | 2142 | 2148 | |
| 116 | 2142 | 2147 | |
| 117 | 2133 | 2148 | |
| 118 | 2166 | 2148 | |
| 119 | 2142 | 2148 | |
| 120 | 2146 | 2148 | |
| 121 | 2165 | 2148 | |
| 122 | 2163 | 2148 | |
| 123 | 2135 | 2147 | |

S and Q can continue to be updated as above, and can be used in order for the model to stabilize on the new level. Once the point is reached where α≈1 and β≈0, the average and variance are considered to be stable again and can go back to the usual way of calculating the variance.

Once the information about blob-allocated pixel values i_{x,y,t} has been updated (and the noise map has also been updated), in a subsequent step S6 blobs are generated based on the blob-allocated pixel values i_{x,y,t}.

Blob generation is the process of iterating over the individual pixels p_{x,y} in a generated noise map, filtering out false positives and forming blobs from connected clusters of outliers. While it is important that the noise map generation is efficient, more computation per pixel p_{x,y} can be offered in the blob generation as long as it is knows that the pixel value in question i_{x,y,t} indeed overstepped the threshold in the noise map generation.

Whereas setting the limits based on mean and sample standard deviation of the recent pixel values i_{x,y,t} works well in most cases, one notable problematic issue arises when parts of the image Iₜ become overexposed. In this case, the signal value tends to be saturated on some value close to the upper limits of the range, and since the affected pixel values i_{x,y,t} as a result stop fluctuating over time, the standard deviation also becomes zero, which in turn means that even the slightest change would lead to blobs being generated.

To address this issue, one can add an additional minimum required deviation, in a step S5, used in the blob generation step as an anti-saturation filter:

┌i_{x,y,t}−μ_{x,y,t}┐>\sqrt{qμ_{x,y,t,}} (21)

where μ_{x,y,t} is the noise model's prediction for the pixel value i_{x,y,t}. If the deviation is less than this, the pixel value i_{x,y,t} is discarded as a non-blob pixel despite it overstepping the initial limits set up by the noise model.

Since square roots are computationally expensive, it is better to use:

┌i_{x,y,t}−μ_{x,y,t}┐²>q²μ_{x,y,t}. (22)

q is >0 but <<1, implying that q² is even smaller. Define:

$$B = \frac{1}{{q}^{2}} . \qquad ( 23 )$$

B is a positive number that controls the filtering limit. Since any number for B that gives the appropriate filtering effect can be selected, one can decide to pick an integer value. In some embodiments, B is at least 10, such as at least 50, such as at least 100. In some embodiments, B is at the most 10000, such as at the most 1000.

Then, the condition can be rewritten as:

B[i_{x,y,t}−\hat{μ}_{x,y,t}]²>\hat{μ}_{x,y,t}. (24)

Since the noise map and the noise model were updated in the same step, the noise model that this currently considered noise map was based on is already lost when arriving at the blob generation step. The noise model data is overwritten in the computer memory each iteration of the method. However, since μ_{x,y,t} was saved (with 15 bits precision in the above example) in the noise map itself, this value can be used instead when calculating (24). If the other terms are appropriately scaled (using fixed-point arithmetic), (24) can also be calculated only using integer math.

After a possible such anti-saturation filtering step, pixel values i_{x,y,t} overstepping the noise model limits (as described above across expressions (1)-(24)) are grouped together into multi-pixel blobs. This can be done using the per se well-known Hoshen-Kopelman algorithm, which is a raster-scan method to form such pixel groups that runs in linear time. During the first pass, it runs through all pixel values i_{x,y,t}. If a pixel value i_{x,y,t} oversteps a limit and it has a neighboring pixel value i_{x±1,y±1,t} that belongs to a blob, it will be added to that same blob. If it has multiple neighboring blob-classified pixel values i_{x±1,y±1,t}, these will be joined into one single blob, and the pixel value i_{x,y,t} is added to the group. Finally, if there are no neighboring blobs, the pixel value i_{x,y,t} will be registered as a new blob. For each blob, the following metrics can be aggregated. This provides different options for estimating the center of the blob. One possibility is to use the absolute modulus of the noise model deviations:

$${\hat{x}}_{1} = \frac{{X}_{{w}^{1}}}{{W}_{1}} ; {\hat{y}}_{1} = \frac{{Y}_{{w}^{1}}}{{W}_{1}} ,$$

and another option is to weight the coordinates by their squared deviations:

$${\hat{x}}_{2} = \frac{{X}_{{w}^{2}}}{{W}_{2}} ; {\hat{y}}_{2} = \frac{{Y}_{{w}^{2}}}{{W}_{2}} . \qquad ( 26 )$$

| Short | Name | Type | Description |
|---|---|---|---|
| X_{w}_{¹} | weightedXSum | uint32 | Σₚ pₓ┌iₚ − μₚ┐. X coordinates |
| | | | of blob weighted by the |
| | | | deviation from the noise model. |
| Y_{w}_{¹} | weightedYSum | uint32 | Σₚ p_{y}┌iₚ − μₚ┐. Y coordinates |
| | | | of blob weighted by the |
| | | | deviation from the noise model. |
| W₁ | weightSum | uint32 | Σₚ┌iₚ − μₚ┐. Sum of all the |
| | | | absolute deviations from the |
| | | | noise model. |
| X_{w}_{²} | sqWeightedXSum | uint32 | Σₚ pₓ┌iₚ − μₚ┐². X coordinates |
| | | | of blob weighted by the |
| | | | squared deviation from the |
| | | | noise model. |
| Y_{w}_{²} | sqWeightedYSum | uint32 | Σₚ p_{y}┌iₚ − μₚ┐². Y coordinates |
| | | | of blob weighted by the |
| | | | squared deviation from the |
| | | | noise model. |
| W₂ | sqWeightSum | uint32 | Σₚ┌iₚ − μₚ┐². Sum of all the |
| | | | square deviations from the |
| | | | noise model. |

Experimental data so far indicates that using (\hat{x}₁;ŷ₁) when the blob is small (blob size in pixels not larger than 16), but using the squared-weighted (\hat{x}₂;ŷ₂) options for larger blobs (number of pixels in blob>32), and interpolating between these for medium-sized blobs achieves a good stereo matching.

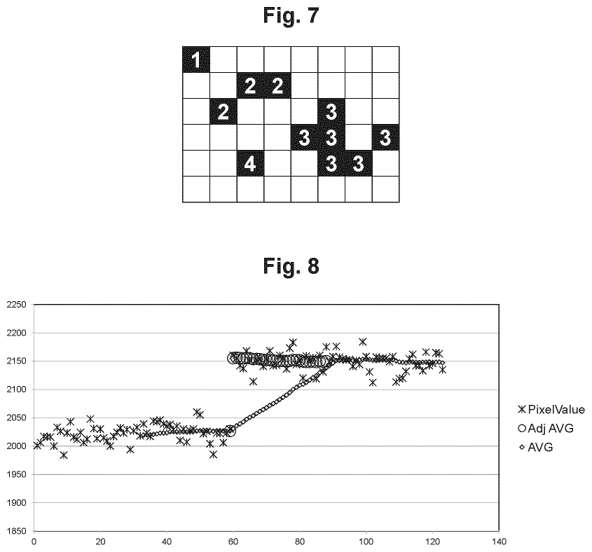

FIG. 7 illustrates an exemplifying clustering of four different detected blobs 1-4 based on individual pixel values i_{x,y,t} found to fulfill the criteria for being considered as part of blobs at time t.

In a subsequent method step S7, performed by the target object tracker 140, detected blobs are correlated across said time-ordered series of digital images Iₜ to determine paths of moving objects through said space. Such correlation can, for instance, use linear interpolation and/or implied Newtonian laws of motion as filtering mechanism, so as to purge blobs not moving in ways that are plausible provided a reasonable model of the types of objects being tracked.

In case several cameras 110 are used, or in case one or several cameras 110 are used together with another type of target object 120 sensor, tracking information available from such available cameras 110 and any other sensors can be combined to determine one or several 3-dimensional target object 120 tracks through the space 111. This can, for instance, take place using stereoscopic techniques, that are well-known in themselves.

In a subsequent step S8, one or several determined 2D and/or 3D target object 120 tracks can be output to an external system, and/or graphically displayed on an display of a track-monitoring device. For instance, such displayed information can be used by a golfer using the system 100 to gain knowledge of the properties of a newly hit golf strike.

In concrete examples, the user (such as a golfer) may be presented with a visual 2D or 3D representation, on a computer display screen, of the track of a golf ball just hit, as detected using the method and system described above, against a graphical representation of a virtual golf practice range or similar. This will provide feedback to the golfer that can be used to make decisions regarding various parts of the golf swing. The track may also be part of a virtual experience, in which a golfer may for instance play a virtual golf hole and the detected and displayed track is represented as a golf shot in said virtual experience.

It is specifically noted that the amount of data necessary to process for achieving such tracks is substantial. For instance, at an updating frequency of 100 images per second and using a 10 Mpixel camera, 1 billion pixel values per second need to be processed and assessed with respect to blob status. This analysis may take place in a depicted space 111 that can include trees and other fine-granular objects displaying rapidly shifting light conditions; rapidly shifting general light conditions due to clouding, and so forth. Using the systems and techniques described herein, it is possible to process the data in essentially real-time, e.g., such that the track can be determined and output while the object is still in the air.

In a subsequent step S9, the method ends.

As mentioned above, the invention also relates to the system 100 as such, comprising the digital camera 110, the digital image analyzer 130 and the moving object tracker 140.

The digital camera 110 is then arranged to depict the space 111 to produce the series of digital images Iₜ as described above. The digital image analyzer 130 is configured to determine said inequality for the pixel values i_{x,y,t} as described above, and to store in the computer memory information indicating that one or several pixel values i_{x,y,t} are part of a detected blob. The moving object tracker 140 is configured to correlate detected blobs across said series of digital images Iₜ as described above.

As also mentioned, the invention also relates to the computer software product as such. The computer software product is then configured to, when executing on suitable hardware as described above, embody the digital image analyzer 130 and the moving object tracker 140. As such, it is configured to receive a series of digital images Iₜ from the digital camera 110, and to perform the above-described method steps performed by the digital image analyzer 130 and the moving object tracker 140. For instance, the digital frames Iₜ can be provided as a continuous or semi-continuous stream of frames from the digital camera 110 (and a set of n most recent considered frames can be analyzed for each frame or set of frames received), or the entire set of N images can be received as one big batch and analysed thereafter. The computer software product can execute on a computer belonging to the system 100, and can as such constitute part of the system 100.

Above, a number of embodiments have been described. However, it is apparent to the skilled person that many modifications can be made to the disclosed embodiments without departing from the basic idea of the invention.

For instance, many additional data processing, filtering, transformation, etc. steps can be taken, in addition to the ones being described herein.

The generated blob data can be used in various ways in addition to the object tracking.

In general, everything which is said in relation to the method is equally applicable to the system and to the computer software product, and vice versa.

Hence, the invention is not limited to the described embodiments, but can be varied within the scope of the enclosed claims.

1. A method for tracking moving objects, the method comprising:
obtaining a series of digital images (Iₜ) at consecutive times (t), the series of digital images (Iₜ) representing optical input from a three-dimensional space within a field of view of the digital camera, the digital camera being arranged to produce said series of digital images (Iₜ) having a corresponding set of pixels, said series of digital images comprising corresponding pixel values, the digital camera not moving in relation to said three-dimensional space during production of said series of digital images (Iₜ);
for two or more of said pixel values, determining an inequality comparing a first value to a second value, the first value being calculated as, or based on, the square of the difference between a pixel value (i_{x,y,t}), of a pixel (p_{x,y}) in question, and a predicted pixel value (\hat{μ}_{x,y,t}), the second value being calculated as, or based on, a product of, firstly, the square of a number Z and, secondly, an estimated variance or standard deviation (σ_{x,y,t}) with respect to historic pixel values for the pixel (p_{x,y}) in question, wherein the predicted pixel value (\hat{μ}_{x,y,t}) is calculated based on the historic pixel values for the pixel (p_{x,y}) in question, the inequality being determined as
$${( n {i}_{x , y , t} - {S}_{x , y , t} )}^{2} > {Z}^{2} ( n {Q}_{x , y , t} - {S}_{x , y , t}^{2} ) ,$$
and, for individual ones of said pixel values and for a number n,
$${S}_{x , y , t} = {\sum }_{j = t - n}^{t - 1} {i}_{x , y , j} and {Q}_{x , y , t} = {\sum }_{j = t - n}^{t - 1} {i}_{x , y , t}^{2} ,$$
and, for individual ones of said pixels, S_{x,y,t} and Q_{x,y,t} are stored in a computer memory;
for pixel values for which said first value is higher than said second value, storing in the computer memory information indicating that the pixel value (i_{x,y,t}) is part of a detected blob; and
correlating, based on the information stored in the computer memory, detected blobs across said series of digital images (Iₜ) to determine paths of moving objects through said three-dimensional space.

2. The method according to claim 1, wherein said inequality is
$${( {i}_{x , y , t} - {\hat{μ}}_{x , y , t} )}^{2} > {Z}^{2} {σ}_{x , y , t}^{2}$$
where \hat{μ}_{x,y,t} is said predicted pixel value and where σ_{x,y,t} is an estimated standard deviation with respect to the historic pixel values (i_{x,y,{t-n,t-1}} for the pixel (p_{x,y}) in question.

3. The method according to claim 1, Z is a number selected such that Z² is an integer such that 10≤Z²≤20.

4. The method according to claim 1, wherein S_{x,y,t}, Q_{x,y,t}, or both, are calculated recursively, whereby a calculated value for the pixel value (i_{x,y,t}) is calculated using a previously stored calculated value of S_{x,y,t}, Q_{x,y,t}, or both, for the pixel (p_{x,y}) but at an immediately preceding time (t−1).

5. The method according to claim 4, wherein
S_{x,y,t} is calculated as S_{x,y,t}=S_{x,y,t-1}+i_{x,y,t}−i_{x,y,t-n} and Q_{x,y,t} is calculated as
$${Q}_{x , y , t} = {Q}_{x , y , t - 1} + {i}_{x , y , t}^{2} - {i}_{x , y , t - n}^{2} = {Q}_{x , y , t - 1} + ( {i}_{x , y , t} + {i}_{x , y , t - n} ) ( {i}_{x , y , t} - {i}_{x , y , t - n} ) .$$

6. The method according to claim 5, wherein the method comprises:
storing in said computer memory S_{x,y,t} and Q_{x,y,t} in combination as a single datatype comprising 12 bytes or less per pixel (p_{x,y}).

7. The method according to claim 5, wherein comprises:
storing in said computer memory, for a particular digital image, a pixmap comprising, for each pixel, said information indicating that the pixel value (i_{x,y,t}) is part of a detected blob.

8. The method according to claim 7, wherein
said information indicating that the pixel value (i_{x,y,t}) is part of a detected blob is indicated in a single bit for each pixel (p_{x,y}).

9. The method according to claim 7, wherein
said pixmap comprises, for each pixel, a value indicating an expected pixel value for that pixel.

10. The method according to claim 9, wherein
said value indicating an expected pixel value for the pixel is achieved by storing a predicted pixel value as a fixed-point fractional number, using a total of 15 bits for the integer and fractional parts.

11. The method according to claim 1, wherein
the predicted pixel value (\hat{μ}_{x,y,t}), the estimated variance or standard deviation (σ_{x,y,t}), or both, is or are calculated based on a set of n historic pixel values (i_{x,y,{t-n,t-1}}) for the pixel (p_{x,y}) in question, where 10≤n≤300.

12. The method according to claim 1, wherein
a number n of previous images considered for the estimation of the estimated variance or standard deviation (σ_{x,y,t}) of the second value is selected to be a power of 2.

13. The method according to claim 1, wherein
said pixel values have a depth across one or several channels of between 8 and 48 bits.

14. The method according to claim 1, wherein
the predicted pixel value, (\hat{μ}_{x,y,t}) is determined based on an estimated projected future mean pixel value (μ_{x,y,t}) in turn determined based on a numerical relationship between historic pixel values and current pixel values for a sampled set of pixels (p_{x,y}) in said series of digital images (Iₜ).

15. The method according to claim 14, wherein
the predicted pixel value (\hat{μ}_{x,y,t}) is determined as \hat{μ}_{x,y,t}=αμ_{x,y,t}+β, where α and β are constants determined so as to minimize Σ_{j,k}(i_{j,k,t}−(αμ_{j,k,t}+β))², where μ_{j,k,t} is said estimated projected future mean pixel value for a pixel (p_{j,k}) in question, and where j and k are iterated over a test set of pixels.

16. The method according to claim 15, wherein
μ_{x,y,t} is an estimated historic mean with respect to pixel values for the pixel (p_{x,y}) in question.

17. The method according to claim 15, wherein
said test set of pixels contains between 1% and 25% of a total set of pixels in a given image.

18. The method according to claim 17, wherein
said test set of pixels is geometrically evenly distributed across the total set of pixels in the given image.

19. The method according to claim 15, wherein the method comprises:
determining the estimated standard deviation (σ_{x,y,t}) according to
$${σ}_{x , y , t}^{2} = {σ}_{x , y , t - 1}^{2} ( 1 - ξ ) + {ξ ( {i}_{x , y , t} - {αμ}_{x , y , t} - β )}^{2} ,$$
where ξ∈]0,1[.

20. The method according to claim 15, wherein the method comprises:
determining that at least one is true of a being further away from 1 than a first threshold value and β being further away from 0 than a second threshold value; and
determining the predicted pixel value (\hat{μ}_{x,y,t}) until it is determined that α is no longer further away from 1 than the first threshold value and β is no longer further away from 0 than the second threshold value.

21. The method according to claim 1, wherein the method comprises:
for said pixel values for which said first value is higher than said second value, only store said information indicating that the pixel value (i_{x,y,t}) is part of a detected blob in case also the following inequality holds: B[i_{x,y,t}−\hat{μ}_{x,y,t}]²>\hat{μ}_{x,y,t}, where i_{x,y,t} is the pixel value in question, where \hat{μ}_{x,y,t} is the predicted pixel value and where B is an integer such that B>100.

22. The method according to claim 21, wherein the method comprises:
using a Hoshen-Kopelman algorithm to group together individual adjacent pixels determined to be part of a same blob.

23. The method according to claim 21, wherein
the moving objects are golf balls.

24. System for tracking moving objects, the system comprising:
a digital camera arranged to represent optical input from a three-dimensional space within a field of view of the digital camera to produce a series of digital images (Iₜ) at consecutive times (t), the digital camera being arranged to produce said series of digital images (Iₜ) having a corresponding set of pixels, said series of digital images comprising corresponding pixel values, the digital camera being arranged to not move in relation to said three-dimensional space during production of said series of digital images (Iₜ);
a computer having an associated computer memory, the computer being configured to run a digital image analyzer;
the digital image analyzer being configured to, for two or more of said pixel values, determine an inequality comparing a first value to a second value, the first value being calculated as, or based on, the square of the difference between a pixel value (i_{x,y,t}), of a pixel (p_{x,y}) in question and, a predicted pixel value (\hat{μ}_{x,y,t}), the second value being calculated as, or based on, a product of the square of, firstly, a number Z and, secondly, an estimated variance or standard deviation (σ_{x,y,t}) with respect to historic pixel values for the pixel (p_{x,y}) in question, wherein the predicted pixel value (\hat{μ}_{x,y,t}) is calculated based on the historic pixel values for the pixel (p_{x,y}) in question, the inequality being determined as
$${( n {i}_{x , y , t} - {S}_{x , y , t} )}^{2} > {Z}^{2} ( n {Q}_{x , y , t} - {S}_{x , y , t}^{2} ) ,$$
and, for individual ones of said pixels values and for a numner n,
$${S}_{x , y , t} = {\sum }_{j = t - n}^{t - 1} {i}_{x , y , j} and {Q}_{x , y , t} = {\sum }_{j = t - n}^{t - 1} {i}_{x , y , t}^{2} ,$$
and, for individual ones of said pixels, S_{x,y,t} and Q_{x,y,t} are stored in the computer memory;
the digital image analyzer being configured to, for pixel values for which said first value is higher than said second value, store in the computer memory information indicating that the pixel value (i_{x,y,t}) is part of a detected blob; and
a moving object tracker being configured to correlate, based on the information stored in the computer memory, detected blobs across said series of digital images (Iₜ) to determine paths of moving objects through said three-dimensional space.

25. The system of 24, wherein the digital image analyzer is configured to determine the predicted pixel value, (\hat{μ}_{x,y,t}) based on an estimated projected future mean pixel value (μ_{x,y,t}) in turn determined based on a numerical relationship between historic pixel values and current pixel values for a sampled set of pixels (p_{x,y}) in said series of digital images (Iₜ).

26. (canceled)

27. The system of 24, wherein the digital image analyzer is configured to, for said pixel values for which said first value is higher than said second value, only store said information indicating that the pixel value (i_{x,y,t}) is part of a detected blob in case also the following inequality holds: B[i_{x,y,t}−\hat{μ}_{x,y,t}]²=\hat{μ}_{x,y,t}, where i_{x,y,t} is the pixel value in question, where \hat{μ}_{x,y,t} is the predicted pixel value and where B is an integer such that B>100.
